(19) United States
(12) Patent Application Publication
(10) Pub. No.: US 2002/0054175 A1
(43) Pub. Date: May 9, 2002

(54) Selection of an alternative

(76) Inventors: Michael Miettinen, Tampere (FI); Antti Sinnemaa, Espoo (FI)

Correspondence Address: Perman & Green, 425 Post Road, Fairfield, CT, 06430-6232, US

(21) Appl. No.: 09/879,438

(22) Filed: Jun. 12, 2001

(30) Foreign Application Priority Data
Jun. 15, 2000 (FI) FI 20001429

(51) Int. Cl. G09G 5/00

(52) U.S. Cl. 345/863

(57) ABSTRACT

A method for recognizing a selection from among at least two alternatives, the method comprising determining the positions corresponding to each alternative in the space surrounding a user on the basis of their distance and direction with respect to the user so that the locations of the positions remain significantly the same with respect to the user irrespective of the user's location; allowing the user to carry out a first movement for moving a member of the body to the position that corresponds to the alternative he desires; recognizing a second movement carried out by the user in the position that corresponds to the alternative the user desires; in response to the second movement, recognizing the selection the user desires as carried out; and providing the recognized selection as output. The invention further relates to a device implementing the method, which can be, for example, a computer or a mobile station.

### FIELD OF THE INVENTION

The present invention relates to the selection of an alternative from a set of alternatives by moving a member of the body.

### BACKGROUND OF THE INVENTION

Currently, there is a wide variety of different kinds of electronic devices available to consumers. A major part of these has a user interface with the help of which a user can control the operation of the device. In this case, the user has to select from at least two alternatives, for example, the volume of sound higher or lower. The most versatile devices provide a user with a large number of different kinds of alternatives to choose from. In a computer environment, a selection can be carried out, for example, by using a graphic user interface, whereupon selecting is rather intuitive. In the Microsoft Windows 95® operating system, a user can select the desired programs and actions by moving a computer mouse for shifting the cursor presented on a display by the desired alternative and by confirming his selection by pressing a specific button. Alternatively, instead of a mouse, a touch screen can be used, in which case the selection is indicated by touching with a finger the point according to the alternative to be selected on the touch screen. When using both a mouse and a touch screen, performing a selection requires a reasonable amount of attentiveness and an accurate movement of the hand. Consequently, carrying out a selection without looking at the display is at least difficult if not impossible for an ordinary user.

Another approach in which the problem of looking at the display can be avoided is the use of speech recognition. By receiving the selections with the help of speech recognition, the user may look anywhere he wants while doing selections. However, speech recognition is prone to errors and often requires a reasonably long practising period for teaching the speech recognition equipment to recognise the user's speech. Speech recognition operates best in quiet circumstances: noise hampers the reliability of recognition. Speech recognition should also be able to take into consideration the speaker's mother tongue, preferably also to operate in it.

A third more recent approach is related to the recognition of the user's movements and the establishment of a so-called virtual reality. Here, the user's movements are recognised, for example, with the help of a video camera and a computer or intelligent clothes that indicate the movements and a computer. A virtual scene is presented to the user, e.g. with the help of a virtual helmet placed on the head, whereupon display elements that position themselves in front of the user's eyes present at best a three-dimensional stereo scene. J. Segen and S. Kumar have presented a method with which by using a single video camera the movements of the user's hand can be followed and even the movement of a forefinger can be noted. The method is described in the publication Computer Vision and Pattern Recognition, 1999, IEEE Computer Society Conference on, Volume: 1, 1999, pages: 479-485. In the publication, FIG. 7 shows a 3-dimensional editor with which objects presented three-dimensionally can apparently be grabbed, they can be shifted and again released. As gestures to be used for selecting and grabbing an object a point gesture with a forefinger and the momentary opening of a hand, i.e. a “reach” gesture are sufficient. This kind of virtual reality is indeed very well suited for many applications and it is easy to learn and use. Objects to be selected (such as the balls in FIG. 7 in the publication) can even be presented to the user, but in order to select from these the user must, however, carefully concentrate on performing the selections.

### SUMMARY OF THE INVENTION

Now, a method and a device have been invented with which the problems mentioned above can be avoided or at least their impact can be mitigated.

A method according to a first aspect of the invention for recognising a selection from a set of at least two alternatives comprises the following steps of:

determining the positions corresponding to each alternative in a space surrounding a user on the basis of their distance and direction with respect to the user so that the locations of the positions remain substantially the same with respect to the user irrespective of the location of the user;

allowing the user to carry out a first movement for moving a member of the body to the position corresponding to the desired alternative;

recognising a second movement carried out by the user in the position corresponding to the alternative the user wants;

in response to the second movement, recognising the selection the user wants as completed; and

providing the recognised selection as an output.

Preferably, the method further comprises displaying the user at least once the positions corresponding to the alternatives as one of the following: virtual images and a selection disc at the level of the user's waist. In this case, the user is informed, with the help of the sense of sight, of the location of the positions to be used for selecting alternatives with respect to himself, and it is easy for him to select the desired alternative. In one alternative embodiment of the invention, the user is informed of the description of the alternative corresponding to each location of the member of the body audiophonically, whereupon the user can obtain the information on the locations of the different alternatives by moving his hand to the positions corresponding to different alternatives and by listening to their descriptions.

Preferably, the method further comprises expressing the user the alternative indicated at any given time. As an advantage of the expression, the risk of an error selection carried out by the user is reduced when the user, before carrying out the second movement, receives a confirmation that he is selecting exactly the alternative he wants.

Preferably, the method further comprises selecting the positions corresponding to the alternatives so that the user may move the member of his body to the desired position on the basis of his spatial memory. Preferably, the positions corresponding to each alternative are also determined as regards their height with respect to the user.

Preferably, the method further comprises recognising the second movement contactlessly. Preferably, the contactless recognition of the second movement is implemented with an optical motion-detecting device. In this case, the use of mechanical parts is avoided in recognising the alternatives, and making selections is made pleasant for the user.

Preferably, the first movement is the movement of the user's hand. Moving a hand for doing a selection is intuitive and easy to learn. Preferably, the second movement is the movement of the user' hand that deviates from the first movement. In one alternative embodiment of the invention, the second movement is the movement of the user's hand in which the user puts his fingers in a position according to some figure.

Preferably, the method further comprises carrying out a certain first operation in response to the output.

Preferably, the method further comprises allowing the user to carry out a certain second operation with a certain third movement of the member of the body. Preferably, the third movement is substantially opposite to the second movement.

An electronic device according to a second aspect of the invention for recognising a selection from a set of at least two alternatives comprises:

means for determining the positions surrounding a user, which correspond to each alternative on the basis of their distance and direction with respect to the user so that the locations of the positions remain substantially the same with respect to the user irrespective of the location of the user;

means for allowing the user to move a member of the body to the position that corresponds to the alternative he desires;

means for recognising a second movement carried out by the user in the position;

means for recognising the carrying out of the selection the user wants in response to the second movement; and

an output for the output of the recognised selection.

Preferably, the device further comprises display means for displaying the positions corresponding to the alternatives to the user, the positions corresponding to the alternatives as one of the following: a virtual image and a selection disc at the level of the user's waist.

Preferably, the device further comprises presentation means for indicating the alternative indicated at any given time, to the user.

Preferably, the means for determining the positions surrounding the user that correspond to each alternative is arranged to determine the positions corresponding to the alternatives so that the user can move the member of his body to the position the user wants on the basis of his spatial memory.

Preferably, the means for recognising the second movement carried out by the user in the position is adapted to recognise the second movement contactlessly.

In one alternative embodiment, the means for recognising the second movement carried out by the user in the position is adapted to be attached to the user.

Preferably, in this case, the means for recognising the second movement is arranged to also recognise the position of the member of the body.

Preferably, the first movement is the movement of the user's hand.

Preferably, the device further comprises means for carrying out a specific first operation in response to the second movement.

Preferably, the device further comprises means for carrying out a specific second function in response to the third movement.

Preferably, the third movement is substantially opposite to the second movement.

Preferably, the locations with respect to the user are respective to the body of the user.

The method and device according to the invention can be utilised in a number of different kinds of devices, such as mobile stations, computers, television apparatuses, data network browsing devices, electronic books, and at least partly electronically controlled vehicles.

### BRIEF DESCRIPTION OF THE DRAWINGS

In the following, the invention will be explained by way of example by referring to the enclosed drawings, in which:

FIG. 1 shows a first selection situation according to a preferred embodiment of the invention;

FIG. 2 shows a second selection situation according to the preferred embodiment of the invention;

FIG. 3 shows a selection device according to the preferred embodiment of the invention;

FIG. 4 shows, as a block diagram, a first system according to the invention;

FIG. 5 shows, as a flow diagram, the operation of the system in FIG. 4; and

FIG. 6 shows, as a block diagram, a second system according to the invention.

### DETAILED DESCRIPTION

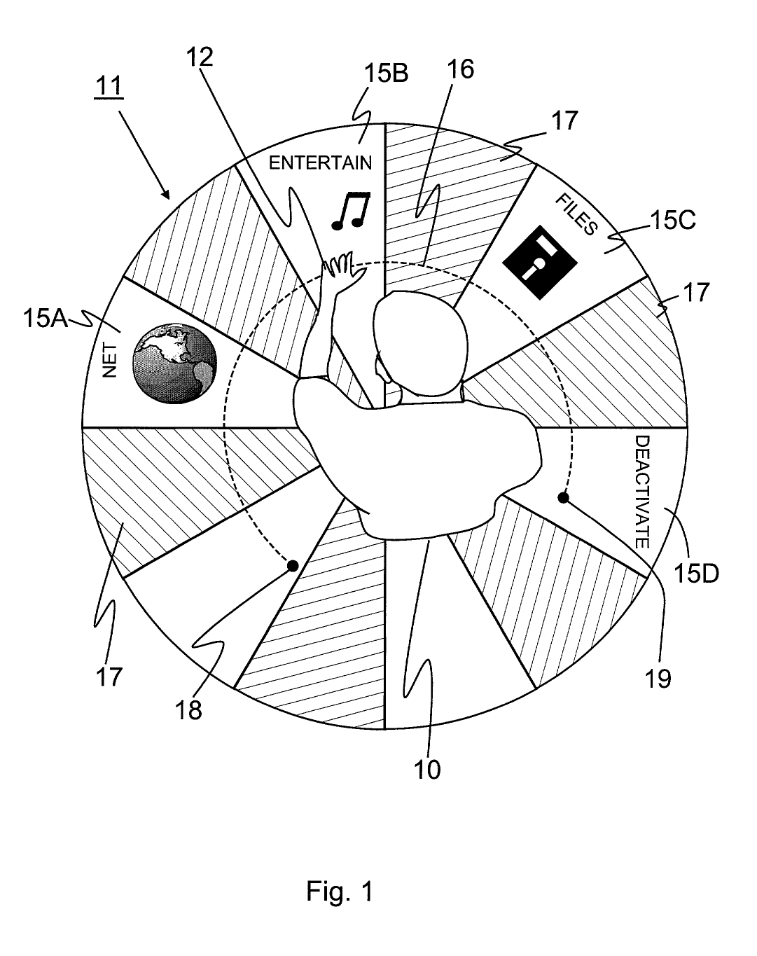

FIG. 1 shows a first selection situation according a preferred embodiment of the invention. In the visual field of a user 10, a selection disc 11 comprising selection areas 15A, 15B, 15C, 15D in the shape of a sector surrounding the user is presented, for example, with virtual glasses. Preferably, the selection disc is presented so that it appears to be at the level of the user's waist. In each selection area, the description of the selection area in question is marked as text and graphic icons. The selection areas are separated from each other by separating areas 17, the purpose of which is to reduce the number of error selections, as will be explained later. The selection areas are so big that the user can extend a hand 12 in front of him and move his whole hand 12 with the arm extended in order to indicate the desired selection by moving his hand around on the selection area corresponding to the selection. The selection area underneath the user's hand is preferably indicated to the user by presenting the selection area in a manner different from the other selection areas, for example as an inverted image or by the use of colours if the other areas are displayed black-and-white. In order to do a selection, the user lowers his hand and “touches” or “penetrates” the selection disc 11 presented to him by the area corresponding to the desired selection (which is a virtual image, that is, only an object presented to the user visually that cannot be touched by hand). Because the selection areas are determined with respect to the user, the location of the user makes no difference as such but the user moves his hand to a position which is in a specific direction with respect to the user, at a specific distance from the user and at a specific height from the floor. Preferably, the user is given a notification of the executed selection, for example as an audio signal by using speech synthesis. After practising for a while the use of a selection disc, an ordinary user begins to remember the approximate position of each selection area and may by using his spatial memory carry out the desired selection without looking at the selection disc at all.

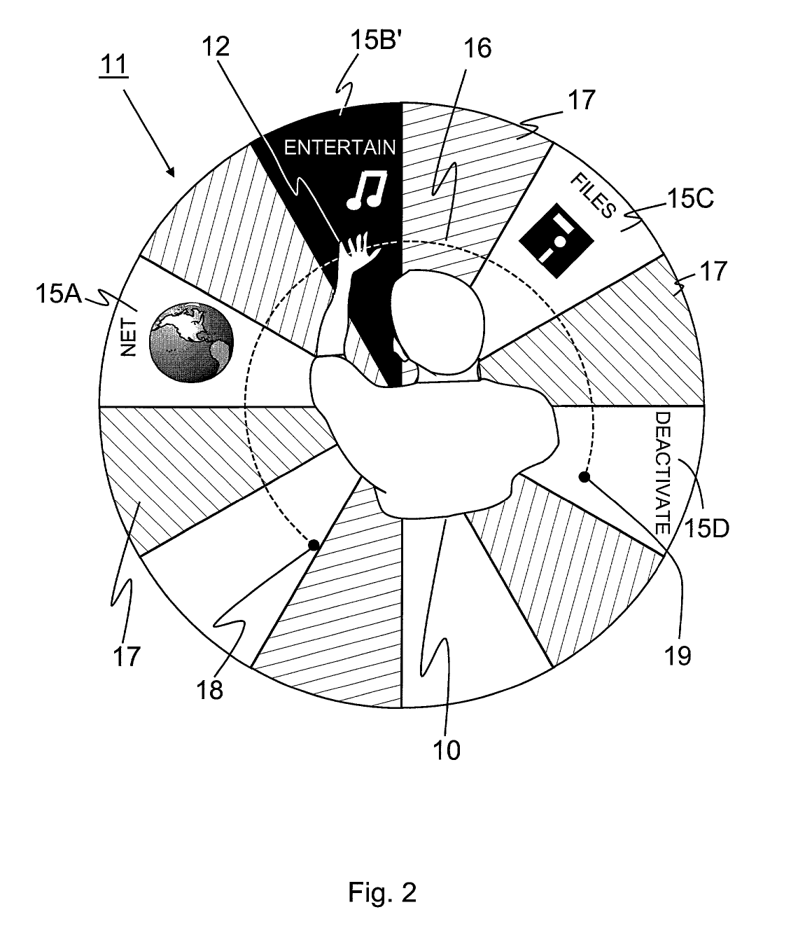

FIG. 2 shows a second selection situation according to a preferred embodiment of the invention. The figure illustrates the indication of a selection to a user. The user's hand is exactly by the selection (Entertainment) according to a selection area 15B′. For indicating the alternative available for selection, the selection area is displayed as the area 15B′ in which the colouring is inverted.

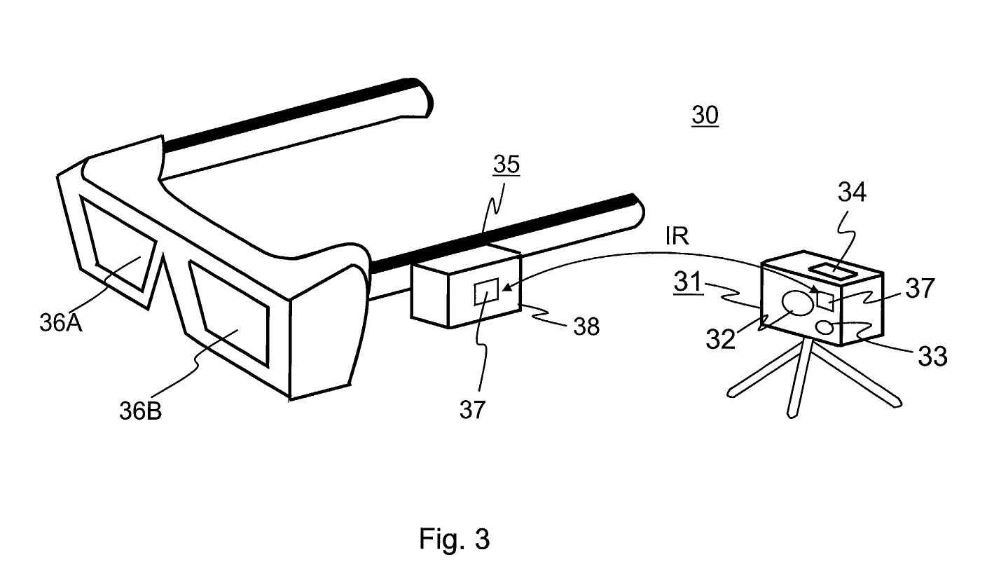

FIG. 3 shows a selection device 30 according to a preferred embodiment of the invention. The selection device comprises a central unit 31, as well as a three-dimensional display device 35. The central unit 31 and the display device 35 are separate components equipped with infrared or LPRF (Low Power Radio Frequency) ports 37. The central unit comprises a camera 32 for monitoring the user's hand movements and processing means (not shown in the figure), a loudspeaker 33 for giving the user an audio response, an infrared port 37 for sending a selection disc to the display device, and a data transmission port 34 for being connected to a computer. The display device comprises a frame 36, a control unit 38 and two display elements 36A and 36B. The control unit 38 is connected to the display elements with cables for transferring a video signal to the elements. The display device can be any device known from prior art, such as StereoGraphics' 93-gram CrystalEyes' Stereo3D visualisation device presented at the Internet address http://www.stereographics.com/. The device comprises an infrared link for transferring an image from the computer to the display device. The display elements 36A and 36B of the visualisation device can be either partly transparent or fully non-transparent.

The selection device shown in FIG. 3 presents the selection disc to the user electronically with the help of the display device. When the camera detects the user doing a selection, the central unit controls the display device to present the selection disc and preferably also to display the alternative available for selection at any given time in a manner different from the other alternatives. The user's hand movements are recognised with the help of the camera contactlessly; the user does not have to touch any switch. In this way, aiming at a switch, as well as problems relating to the wearing of mechanical switches are avoided. With the selection device shown in FIG. 3, the user's movements are also recognised wirelessly.

In an alternative embodiment of the invention, the user attaches a transparent plastic film to his glasses or sunglasses. The image of a selection disc has been printed on the film so that when the user looks through it he sees the selection disc. By turning his head slightly downwards, the user can see the selection disc approximately in its correct position.

In a second alternative embodiment of the invention, the camera is adapted to be carried with and supported on the user so that the camera can monitor the user's hand movements. The camera can, for example, be attached to the display device to be placed on the user's head, to the user's clothes around the shoulder or to the user's belt, for example. An advantage of the camera placed in the display device is that, in this case, the camera turns along with the display device, whereupon the selection areas, which are recognised with the guidance of the camera correspond to the selection areas presented in the user's visual field irrespective of the movements of the head. On the other hand, an advantage of the camera attached to the belt is that the system of co-ordinates of the user's hand movements corresponds to the hand movements with respect to the user's waist. This being the case, for example, moving the head does not affect the selection areas. This is an advantage, for example, if the user carries out selections based on his spatial memory.

In yet another alternative embodiment of the invention, an unobstructed visual field straight ahead of him is arranged for the user. This can be implemented so that the display elements are formed at least partly transparent or quite simply by shaping the display elements in the manner of the lenses of low reading glasses so low that the user can look ahead over the display elements. Thus, the user can also use the selection procedure according to the invention when moving, whereupon he can easily look either ahead or towards the selection disc.

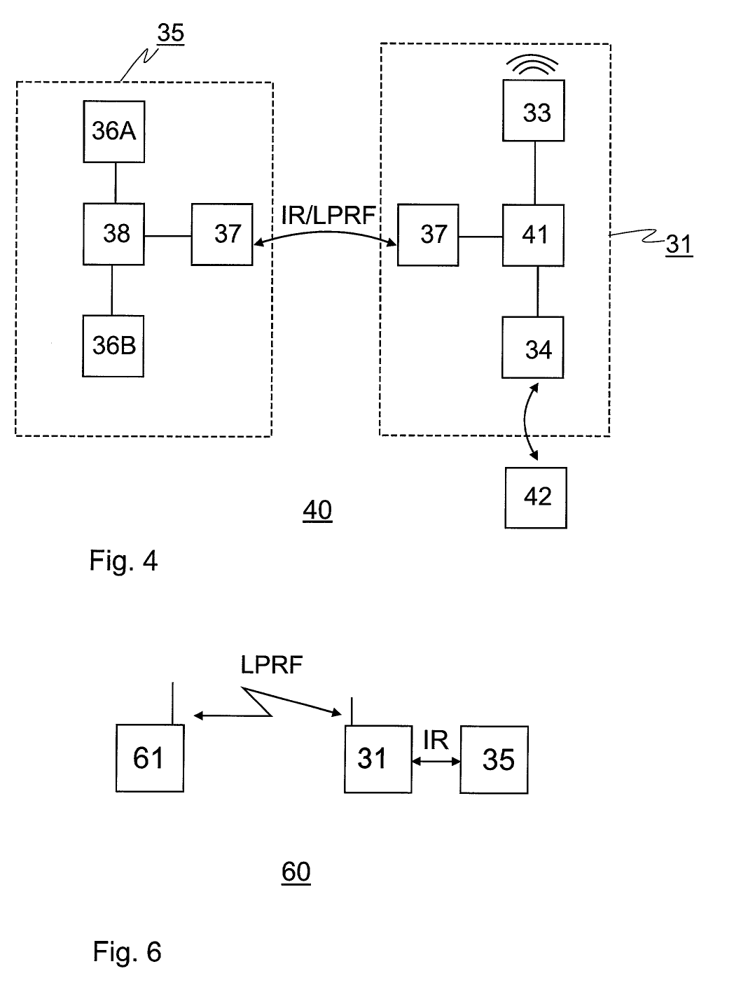

FIG. 4 is a block diagram that shows a first system 40 according to the invention comprising the selection device shown in FIG. 3, as well as a computer 42 controlled by it. The system comprises a display device 35, which includes a control unit 38. The control unit controls display elements 36A and 36B, as well as a first infrared port 37. The system also includes a central unit 31 that controls the display device. The central unit comprises a second infrared port 37, a loudspeaker 33, a data transmission port 34 and a processor 41 that controls them. The data transmission port is any data transmission port known from prior art. The central unit provides through the data transmission port the controlled computer 42 with the selections done by the user. Preferably, the central unit is also adapted to form a selection disc according to the selection alternatives provided by the computer, for example, so that the computer informs in succession the alternatives to be presented to the user and the control unit forms the selection disc to be presented with the display device according to these alternatives.

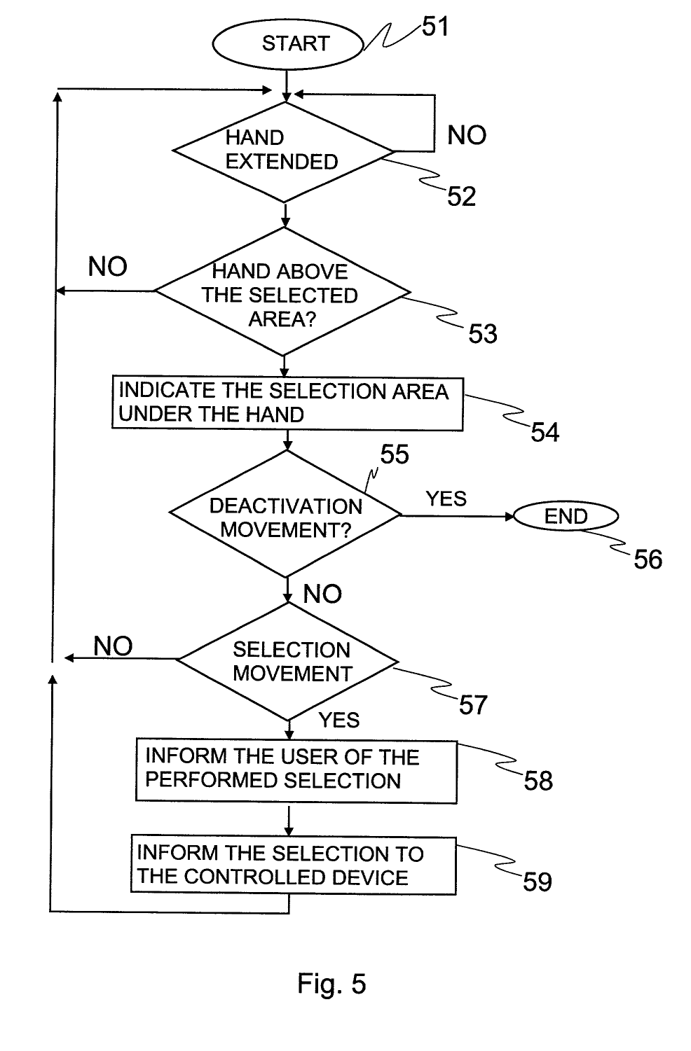

FIG. 5 is a flow diagram that shows the operation of the system in FIG. 4. The operation begins from Block 51 in which the system is made ready for operation and the central unit forms the selection disc electrically. As for the recognition of a selection, it is not even necessary to present the selection disc to the user, because the user can carry out the selection on the basis of his spatial memory.

In Block 52, the system checks whether the user's hand is extended. If not, the execution returns to re-check whether the hand is extended. If yes, in Block 53, it is checked whether the user's hand is on some selection area. If no, the execution returns to Block 52 (or alternatively to Block 53). If the hand is on a selection area, the selection area underneath the hand is indicated to the user, for example, using speech synthesis by reading the name of the selection or by changing the selection area presented to the user with the display device. In Block 55, it is checked whether the user makes a deactivation movement. If yes, the receiving of selections is stopped in Block 56 and the user is informed of this.

If the user did not make a deactivation movement, it is checked, in Block 57, whether the user makes a selection movement. If he doesn't, it is returned to Block 52, otherwise, in Block 58, the user is informed of the performed selection. The notification can be made audiophonically and/or visually. In Block 59, the selection is given as output to the device controlled by the system.

Preferably, the selection movement is the movement of the user's hand towards the selection disc and the deactivation movement is the movement of the hand extended forward away from the selection disc. In this example, where the selection disc is presented at the level of the user's waist, the selection movement is directed downwards. The returning of the hand as extended forward after the activation movement has been made is preferably not interpreted as a deactivation movement. In an alternative embodiment of the invention, the deactivation movement is not at all dependent on by which alternative the hand is.

The selection procedure according to the invention can also be used to control menus. Preferably, however, the number of menus is kept small so that the user can learn to remember the purpose of the selection areas of each menu. For example, by using the selection area 15B referring to entertainment applications the user may first select one menu in which, in the selection area 15A, there are films, in the selection area 15B, there is music and so forth. Preferably, both a film watching application and a music listening application (which are thus started in the case of the example mentioned above in the selection areas 15B and then 15A or 15B) use the same selection areas to select the next piece, to start and stop playback, as well as to exit the application. Hence, it is relatively easy for the user to learn the hand movements required for the use of the commonest applications so that he can also control the applications without seeing the selection disc.

In an alternative embodiment of the invention, instead of the deactivation movement, a specific second selection movement is monitored which deviates from the selection movement that was monitored earlier in Block 57. If, for example, the selection movement in Block 57 causes the sound volume to increase, this second selection movement may cause an opposite function, for example the lowering of the sound. If again the hand is extended, for example, by the “back” button of an application using data network browsing, the second selection movement can implement an opposite function, that is, forwarding. This kind of functionality dependent on the alternative to be selected enables intuitive implementation as an example to the just mentioned feature known from network browsers.

FIG. 6 is a block diagram that shows a second system 60 according to the invention. The system comprises a mobile station 61, a central unit 31, and a display device 35. The mobile station 61 is arranged to recognise by means of speech recognition a key word uttered by the user and in response to it, to begin the doing of a selection. It informs the central unit 31 of the starting of the selection and the central unit controls the display device 35 to present a selection disc to the user. The central unit 31 monitors the user's hand movements and expresses the selection done by the user to the mobile station 61. After receiving the selection, the mobile station informs the central unit that selections will not be done anymore, and the central unit stops presenting the selection disc or alternatively, the mobile station waits for further selections. Preferably, the mobile station starts itself the selection situation when receiving a call or when otherwise requiring the user's selection.

In an alternative embodiment of the invention, the central unit 31 and the mobile station 61 are integrated into a single device. Preferably, the central unit's camera is also adapted to be used for visual communication.

The arrangement according to the invention for doing selections can be used, for example, to use different kinds of menus. Because the user's selections are recognised on the basis of fairly wide hand movements, the selections can be recognised reliably and an experienced user does not always have to look at any selection display. Selections can also be done more rapidly than, for example, when using speech recognition because instead of uttering words, the user can do selections by rapid hand movements.

A preferred embodiment of the invention was described above by way of example. Within the scope of the invention, the practical implementation can be modified in a number of ways, for example:

1. A selection disc is not presented to the user at all unless the user separately requests for it.

2. Instead of a selection disc, only an arc is presented the parts of which correspond to the selection areas.

3. Instead of a hand movement, the movements of some other member of the body are monitored, e.g. the movements of the head or a leg. However, limbs, hands in particular, are often easier to move than the head.

4. Monitoring the hand extended by the user at any given time, whereupon the user may select selections by using either of his hands.

5. Grouping selection areas side by side in at least two rows but so far away from each other and in so wide areas that the user can select the desired alternative on the basis of his spatial memory. As an example of this, the selection areas can be arranged in a big 2-dimensional matrix or in two different arcs for using one of which the user bends his elbow and moves his hand with the elbow bent at an angle of approximately 90 degrees. The other arc again corresponds to the moving with straight arms described above. In this case, the sectors shown in FIGS. 1 and 2 can be divided into two parts: the part of the sector immediately next to the user can act as the selection area for starting a first activity and the part of the sector on the outer periphery can act as the selection area for starting a second, possibly opposite activity. It should be noted that also in the case of the selection areas arranged as a matrix, the user's hand still proceeds along a specific arc when the user moves it from one selection area to another selection area.

6. Instead of a camera, any other method recognising the user's wide hand movements can be used, for example, by utilising a tape that recognises its position (Measurand Inc, S1280CS/S1680 Shape tape™) attached to the sleeve of a shirt to be put on the user. When the user's hand moves, the tape attached to the sleeve changes its shape and indicates the position of the hand.

7. A selection movement does not have to reach to a specific level but, for example, a hand movement that is longer than a threshold length or faster than a threshold speed, deviating from the direction of the selection disc level may indicate a selection.

8. Defining as a selection movement some hand signal in which the user forms with his fingers a specific figure, for example, points with his finger or opens his fist and spreads the fingers apart. In this case, the hand does not have to move from one place to another but the user may keep his hand in its place. When using a hand signal, the height of the hand can be left disregarded and allow the user to select the desired selection area at any height. This is of particular benefit in the case of the embodiment presented in Point 5, where the selection areas are grouped in two arcs at different distances from the user, because when moving a hand with the elbow bent the hand's natural course is already lower than if the hand is moved with the elbow stretched.

9. Connecting to the earpieces of the display device, in the vicinity of the user's ears, stereo-loudspeakers and repeating the sounds given to the user through these loudspeakers. Preferably, in this case, the user is provided with an audio scene corresponding to the selection wherein, for example, the selection done on the left side is confirmed merely with the loudspeaker on the side of the left ear.

10. Although the selection disc was presented here as being at the level of the user's waist and parallel with the horizontal plane, it can be formed, for example, at the level of the shoulder, as a vertical plane by the user's shoulder or even diagonally.

11. Turning either the selection disc and the location of the positions to be recognised so that correspondence between them remains even if the user turned his head.

12. Also maintaining the correspondence between the selection areas and the floor under the user. If, for example, the user turns his head or even his whole body counterclockwise, so the selection disc presented to the user is turned clockwise and the user's hand movements are also proportioned to the floor. In this case, the selection disc can be better extended over an arc of 180 degrees so that it extends partly behind the user. This can be implemented, for example, by sewing a tape onto the user's clothes that recognises a change of form, reaching from the user's ankle along the back of a leg and the back at least to the user's neck and preferably all the way to the display device. By measuring the twist of the tape between the ankle and the upper back, the twist of the user's shoulders on the horizontal plane with respect to the floor can be ascertained (for example, due to the partial turning of the user while standing in position). By using this twist, the correspondence between the floor and the user's hand movements can be maintained. This enables the hand movements to be recognised with a motion detecting equipment supported on the user, e.g. with intelligent clothes. Preferably, the tape reaching from the ankle to the neck is attached at its upper end to the frame of the display device with a magnet simultaneously forming at least two electric contacts. By using these contacts, the display device can receive from the tape motion data and transfer the data further to the central unit. The turn of the user's head with respect to the floor can then be determined by measuring the twist, parallel to the horizontal plane, between the display device turning with the head and the floor.

This paper presents the implementation and embodiments of the present invention with the help of examples. A person skilled in the art will appreciate that the present invention is not restricted to the details of the embodiments presented above, and that the invention can also be implemented in another form without deviating from the characteristics of the invention. The embodiments presented above should be considered illustrative, but not restricting. Thus, the possibilities of implementing and using the invention are only restricted by the enclosed claims. Consequently, the various options of implementing the invention as determined by the claims, including the equivalent implementations, also belong to the scope of the invention.

1. A method for recognising a selection from a set of at least two alternatives, the method comprising:
determining the positions corresponding to each alternative in the space surrounding a user on the basis of their distance and direction with respect to the user so that the locations of the positions remain substantially the same with respect to the user irrespective of the location of the user;
allowing the user to carry out a first movement for moving a member of the body to a position corresponding to an alternative the user desires;
recognising a second movement carried out by the user in the position corresponding to the alternative the user desires;
in response to the second movement, recognising the selection the user desires as completed; and
providing the recognised selection as an output.

2. A method according to claim 1, further comprising
displaying the user at least once the positions corresponding to the alternatives as one of the following: virtual images and a selection disc at the level of the user's waist.

3. A method according to claim 1, further comprising
demonstrating the user the alternative indicated at any given time.

4. A method according to claim 1, further comprising
recognising the second movement contactlessly.

5. A method according to claim 1, wherein the first movement is the movement of the user's hand.

6. A method according to claim 1, further comprising
carrying out a certain first function in response to the output.

7. A method according to claim 1, further comprising
allowing the user to carry out a certain second activity with a specific third movement of the member of the body.

8. An electronic device for recognising a selection from a set of at least two alternatives, the device comprising:
means for determining positions surrounding the user that correspond to each alternative on the basis of their distance and direction with respect to the user so that the locations of the positions remain substantially the same with respect to the user irrespective of the location of the user;
means for allowing the user to move a member of the body to a position corresponding to an alternative the user desires;
means for recognising a second movement carried out by the user in the position;
means for recognising the carrying out of the selection the user desires in response to the second movement; and
an output for outputting the recognised selection.

9. A device according to claim 9, wherein
the device further comprises display means for displaying the positions corresponding to the alternatives to the user, the positions corresponding to the alternatives as one of the following:
a virtual image and as a selection disc at the level of the user's waist.

10. A device according to claim 9, wherein
the device further comprises presentation means for indicating the alternative indicated at any given time to the user.

11. A device according to claim 9, wherein
the means for recognising the second movement carried out by the user in the position are adapted to recognise the second movement contactlessly.

12. A device according to claim 9, wherein
the first movement is the movement of the user's hand.

13. A device according to claim 9, wherein
the device further comprises means for carrying out a certain first function in response to the second movement.

14. A device according to claim 9, wherein
the device further comprises means for carrying out a specific second function in response to the third movement.

15. A device according to claim 9, wherein
the means for recognising the second movement carried out by the user in the position are adapted to be attached to the user.

16. A device according to claim 9, wherein
the device comprises at least one of the following: a mobile station, a computer, a television apparatus, a data network browsing device, an electronic book, and an at least partly electronically controlled vehicle.
